(19) United States
(12) Patent Application Publication
(10) Pub. No.: US 2004/0196268 A1
(43) Pub. Date: Oct. 7, 2004

(54) Input module and operating method thereof

(75) Inventors: Huang-Chang Hsu, Taoyuan (TW); Chien-Shih Hsu, Taipei (TW)

Correspondence Address: QUINTERO LAW OFFICE, 1617 BROADWAY, 3RD FLOOR, SANTA MONICA, CA, 90404, US

(73) Assignee: Darfon Electronics Corp.

(21) Appl. No.: 10/817,256

(22) Filed: Apr. 3, 2004

(30) Foreign Application Priority Data
Apr. 7, 2003 (TW) 92107874

(51) Int. Cl. G09G 5/00

(52) U.S. Cl. 345/173

(57) ABSTRACT

An input module and operation method thereof. The input module includes a base with a post and a touchpad movably thereon, perpendicular thereto. The touchpad includes a touch-sensitive input surface with a plurality of defined character areas. Contacting one of the character areas and pressing the touchpad generates corresponding character output.

### BACKGROUND OF THE INVENTION

1. Field of the Invention

The present invention relates to an input module and operating method thereof, and in particular to an input module combining the functions of touchpads and keypads.

2. Description of the Related Art

Presently, touchpads and keypads are common input modules for notebook computers and other mobile electronic devices. In FIG. 1, a notebook computer 10 comprises a touchpad 11 to control a cursor 12 on the monitor. The keyboard 13 of the notebook computer 10 is a basic input device for data-input.

The touchpad 11 and keyboard 13 of a conventional notebook computer 10, however, are separated, taking up considerable space. Furthermore, users must shift position between the keyboard 13 and the touchpad 11 during input, causing inconvenience.

### SUMMARY OF THE INVENTION

Accordingly, an object of the invention is to provide an input module combining the functions of a keypad and a touchpad to increase convenience.

The present invention provides an input module comprising a base with a post thereon and a touchpad movably disposed on the post, perpendicular thereof.

In a preferred embodiment, the input module further comprises a frame disposed on the base surrounding the touchpad, which moves therein. A scissors-type support mechanism is disposed between the base and the touchpad. The touchpad comprises a touch-sensitive input surface defining a plurality of character areas for data input.

The present invention further provides an operating method for an input module. First, an input module having a base with a post and a touchpad movably disposed thereon is provided. The touchpad has a touch-sensitive input surface with a plurality of defined character areas for data input. During input, a first character area of the touchpad is pressed, and corresponding character information is output.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings which are given by way of illustration only, and thus are not limitation of the present invention, and wherein:

FIG. 1 is schematic view of a conventional notebook computer.

FIG. 2 is a cross section of an input module of the invention;

FIG. 3 is an exploded view of an input module of a first embodiment of the invention;

FIG. 4 is a cross section of an input module of a second embodiment of the invention;

FIG. 5 is a flowchart of an operating method of the invention; and

FIG. 6 is a flowchart of another operating method of the invention.

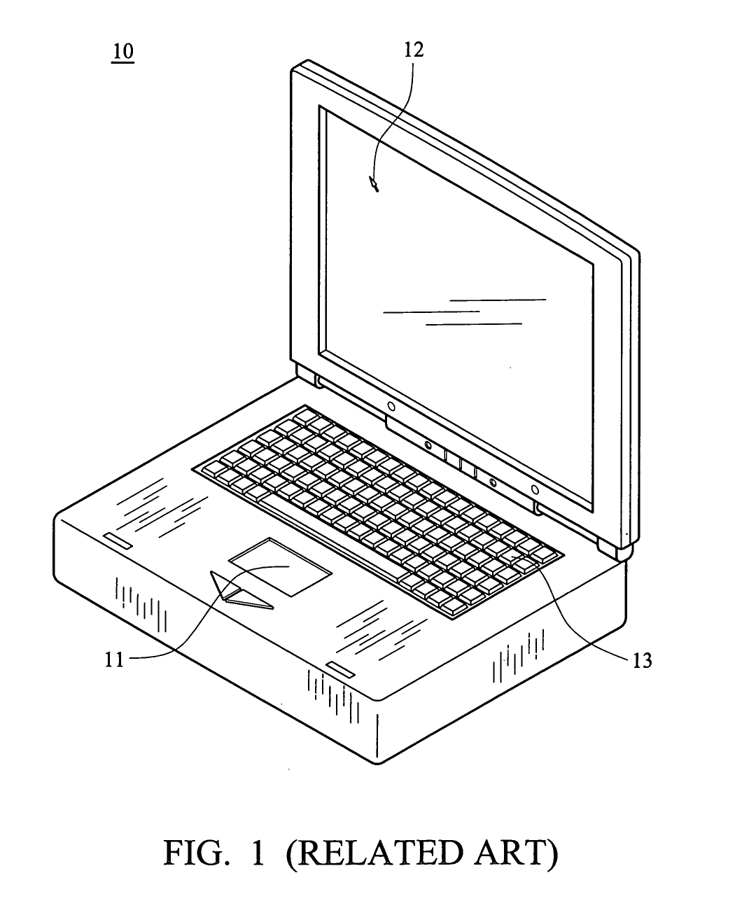

### DETAILED DESCRIPTION OF THE INVENTION

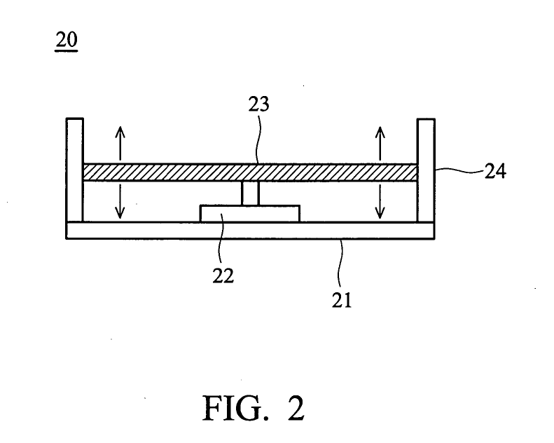

FIG. 2 is a cross section of an input module of the invention. In FIG. 2, an input module 20 comprises a base 21 with a post 22 and touchpad 23 movably disposed thereon. A frame 24 disposed on the base 21 surrounds the touchpad 23, such that the touchpad 23 can only be moved vertically between an upper position and a lower position. Thus, the post 22 is pressed and registers input when the touchpad 23 is pressed down.

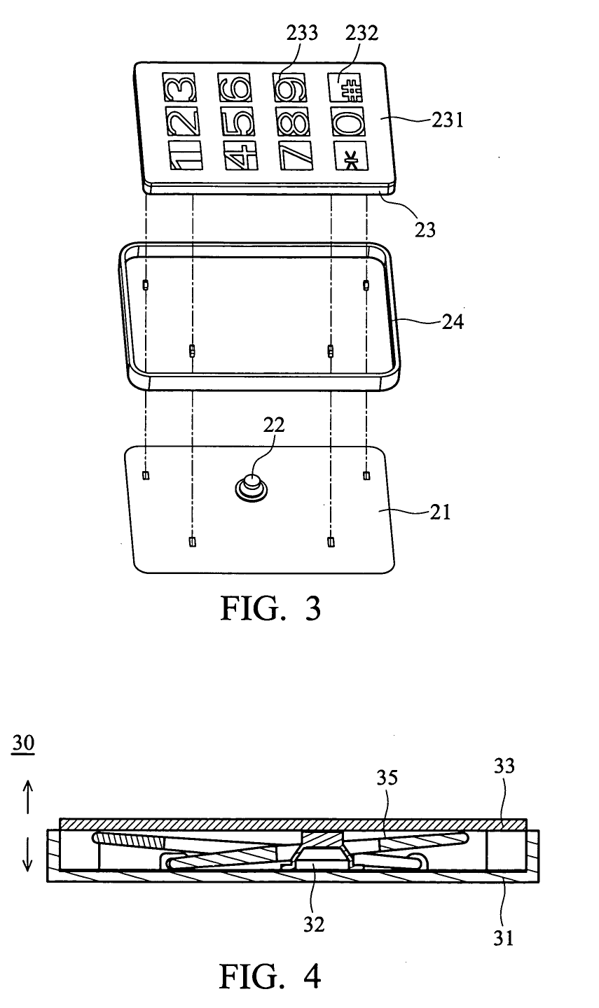

FIG. 3 shows the input module in a first embodiment of the invention. In FIGS. 2 and 3, the touchpad 23 comprises a touch-sensitive input surface 231 defining a plurality of character areas 232, 233. The touch-sensitive input surface 231 comprises a plurality of characters 232 and numbers 233. The touch-sensitive input surface 231 shown in FIG. 3 is a preferred example, but the disclosed is not limited thereto. The input module 20 outputs information of a relative character when a specific character area 232, 233 is touched and pressed. Thus, an electronic device, such as a notebook computer, with the input module 20 of the invention receives corresponding character information and displays the defined character on a monitor, without using a conventional keyboard or keypad.

FIG. 4 shows an input module in a second embodiment of the invention. In FIG. 4, an input module 30 also comprises a base 31 with a post 32 and a touchpad 33 movably disposed thereon. A frame of the base 31 surrounds the touchpad 33. Furthermore, a scissors-type support mechanism 35 is disposed on the base 31, supporting the touchpad 33 and increasing the stability thereof.

The input module of the invention provides functions of both cursor operation via touchpad and keypad-based input. The profile of an electronic device or notebook computer with this input module can be reduced correspondingly. In one aspect, a flexible printed circuit board can be disposed on the base under the touchpad to replace the post, presenting a keyboard or keypad, such that characters can be input directly according to the corresponding character areas.

The following paragraph utilizes a notebook computer with an input device of the present invention to provide description of operating methods thereof.

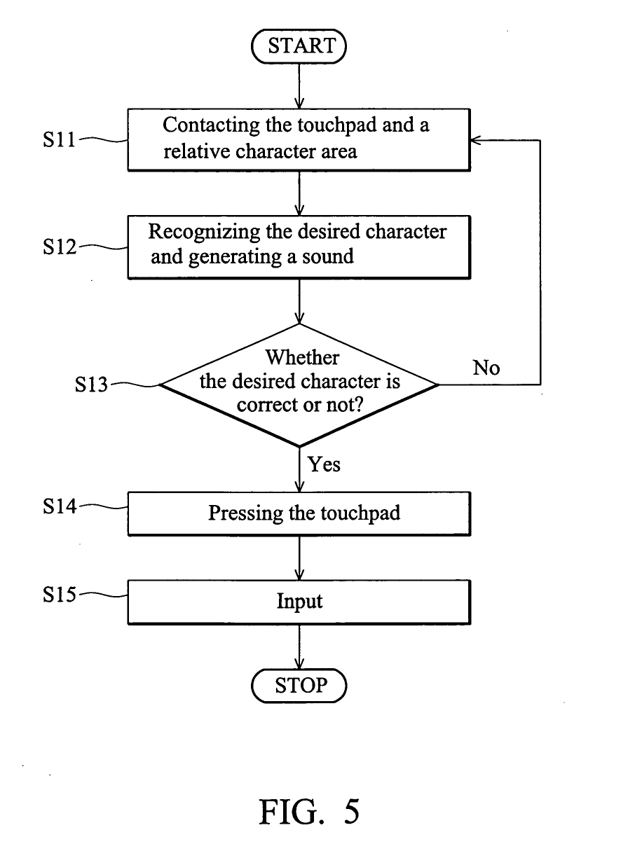

FIG. 5 is a flowchart of an operating method of the invention. First, an input module 20 of the invention is used in a notebook computer (not shown). When the notebook computer is in a data-input mode, the touchpad 23 and a relative character area thereon receive contact, as shown in FIG. 3 (S11). The notebook computer receives and processes the output through a dedicated program and generates a characteristic sound corresponding to the characters (S12), conforming correct input (S13). If the desired entry is indicated, contacting the touchpad again confirms (S14), completing the input cycle (S15).

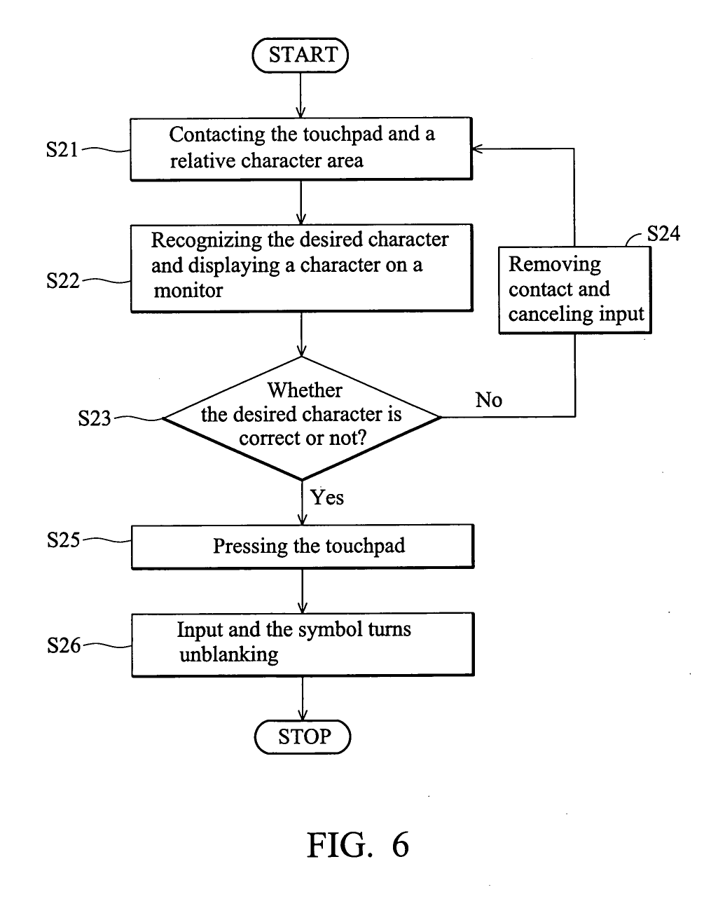

FIG. 6 is a flowchart of another operating method of the invention.

First, an input module 20 of the invention is used in a notebook computer (not shown). When the notebook computer is in a data-input mode, the touchpad 23 and a relative character area thereon receive contact, as shown in FIG. 3 (S21). The notebook computer receives and processes the output through a dedicated program and displays a characteristic symbol corresponding to the characters (S22), conforming correct input (S23). If incorrect input is indicated, removing contact from the touchpad cancels input (S24). If the symbol is correct, the user pressing the touchpad confirms (S25), completing the input cycle (S26).

The audio and visual feedback provide confirmation of desired input, increasing the accuracy of the input method.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An input module, comprising:
a base;
a post disposed on the base; and
a touchpad movably disposed on the post, perpendicular thereto.

2. The input module as claimed in claim 1, further comprising a frame disposed on the base surrounding the touchpad moving therein.

3. The input module as claimed in claim 1, further comprising a scissors-type support mechanism disposed between the base and the touchpad.

4. The input module as claimed in claim 1, wherein the touchpad comprises a plurality of defined character areas.

5. The input module as claimed in claim 4, wherein the touchpad comprises a touch-sensitive defining the character areas.

6. The input module as claimed in claim 5, wherein the touch-sensitive input surface comprises a plurality of alphanumeric character areas.

7. An operating method for an electronic device with a monitor, comprising the steps of:
providing an input module having a base with a post and a touchpad movably thereon, wherein the touchpad comprises a touch-sensitive input surface with a plurality of defined character areas;
contacting the touchpad within a defined character area; and
pressing the touchpad.
